(19) United States
(12) Patent Application Publication
(10) Pub. No.: US 2009/0253571 A1
(43) Pub. Date: Oct. 8, 2009

(54) Composite oxide particles and production method thereof

(75) Inventors: Shinsuke Hashimoto, Nikaho-shi (JP); Tomohiro Yamashita, Nikaho-shi (JP); Tomoaki Nonaka, Nikaho-shi (JP); Hiroshi Sasaki, Nikaho-shi (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/382,935

(22) Filed: Mar. 26, 2009

(30) Foreign Application Priority Data
Mar. 31, 2008 (JP) 2008-094096

(51) Int. Cl. C04B 35/468

(52) U.S. Cl. 501/138

(57) ABSTRACT

The invention intends to provide a precursor material for manufacturing dielectric fine particles, typically barium titanate particles, having uniform particle diameter and particle characteristics, and manufacturing method thereof. The composite oxide particles according to the present invention, which is the precursor material for barium titanate particles, substantially consists of 75 to 25 mol % barium titanate phase and 25 to 75 mol % titanium dioxide phase, and is produced by heat treating a mixed powder consisting of 100 mol % titanium dioxide particles and 25 to 75 mol % barium compound particles at 500° C. or more and less than 900° C.

### BACKGROUND OF THE INVENTION

1. Field of the Invention

The present invention relates to composite oxide particles preferably used as precursor of dielectric particles, typically barium titanate particles, particularly composite oxide particles suitably used as precursor for manufacturing barium titanate fine particles having uniform particle characteristics.

2. Description of the Related Art

Barium titanate (BaTiO₃) is widely used for dielectric layer of ceramic capacitor. The dielectric layer is obtained by forming green sheet from paste including barium titanate particles, and sintering the sheet. Barium titanate particles used for such application is generally manufactured by solid-phase synthesis method. With the solid-phase synthesis method, barium titanate particles are obtained by wet-mixing barium carbonate (BaCO₃) particles and titanium oxide (TiO₂) particles, drying the mixed particles, then, firing the same at a temperature around 900 to 1200° C. causing chemical reaction between barium carbonate particles and titanium oxide particles in solid-phase.

Firing mixed powder of barium carbonate particles and titanium dioxide particles is generally carried out at the above-mentioned firing temperature, elevated from around room temperature. When a mixed powder of barium carbonate particles and titanium dioxide particles are fired, production of barium titanate begins at around 500° C. under reduced pressure (in vacuum), and at around 550° C. under atmospheric pressure. On the other hand, it is known that particle growth of barium carbonate, a raw material, begins at around 400 to 800° C. Particle growth of titanium dioxide begins at around 700° C.

Therefore, particle growth of barium carbonate particles and titanium dioxide particles is accelerated during the elevated temperature process of mixed particles. Subsequently performing reaction at predetermined firing temperature, where barium carbonate particles and titanium oxide particles having large diameter react, barium titanium powder having large diameter is produced. Further, dispersion of barium carbonate particles and titanium dioxide particles in mixed powder used in the solid-phase method is not always uniform. Therefore, variable concentration of barium carbonate particles in mixed powder can be seen. Particle growth of barium carbonate particles is accelerated at a part where barium carbonate particles are highly condensed and produces large barium carbonate particles; to the contrary, particle growth is hard to occur at a part where condensation of barium carbonate particles is low. Same phenomenon can be seen with titanium dioxide particles. Further, irregular shaped particles are also produced by particle bonding among barium carbonate particles or the same among titanium dioxide particles. As a result, particle diameter and characteristics of titanium dioxide particles and barium carbonate particles involved in the reaction become nonuniform, and the same of the obtained barium titanate particles also show variations.

Recently, downsizing of capacitor is demanded, however, there is a limitation for thinning dielectric layers when using paste including barium titanate particles with large diameter. Accordingly, to make thinner dielectric layers, barium titanate powder obtained by the above method are pulverized to prepare a powder having desired particle diameter. However, said pulverization takes time and is costly, and the obtained particles have nonuniform particle characteristics. Further, when manufacturing capacitor using barium titanate particles having variable particle diameters and nonuniform particle characteristics, electric characteristics of capacitor become unstable. Accordingly, there is a demand for a simple method to produce barium titanate particles having small particle diameter and uniform particle characteristics.

During temperature elevating process of mixed particles, by inhibiting particle growth and particle bonding of barium carbonate particles and titanium dioxide particles, it may enable to produce particulate barium titanate particles having uniform particle diameters and particle characteristics. Japanese unexamined patent publication H10-338524 describes a manufacturing method of barium titanate particles wherein barium carbonate particles having relatively large particle diameter and titanium dioxide particles having small particle diameter are mixed, then, the mixed powder was fired, in order to inhibit particle growth of barium titanate particles. More precisely, barium carbonate particles having specific surface area of 10 m²/g or less and titanium dioxide particles having specific surface area of 15 m²/g or more are used. With this method, barium carbonate particles having large particle diameter are surrounded by titanium oxide particles having small particle diameter and mutual contact among barium carbonate particles are inhibited and particle growth of barium carbonate particles are prevented.

However, there is a limitation for miniaturizing barium titanate powder since barium carbonate particles having relatively large particle diameter are used as a raw powder. Further, reaction slowly progresses when using particles having large particle diameter, therefore, it is required to fire for a long time or at a high temperature to obtain uniform barium titanate, which leads to a problem on energetic efficiency. Furthermore, with the above-mentioned method, it will not be possible to inhibit particle bonding and particle growth among titanium dioxide particle. Therefore, irregular shaped and large titanium dioxide particles may be produced before the production of barium titanate. Accordingly, there is a limitation for controlling particle diameter and particle characteristics of barium titanate particles.

Japanese unexamined patent publication H11-199318 further describes a manufacturing method of barium titanate wherein barium carbonate particles and titanium dioxide particles, having specific surface area of 5 m²/g or more are mixed, at a molar ratio of Ba/Ti with 1.001 to 1.010, then, the mixed particles are fired. However, this method cannot also inhibit particle bonding and particle growth among titanium dioxide particles during firing process. Therefore irregular shaped and large titanium dioxide particles may be produced before the production of barium titanate particles. Accordingly, there is a limitation for controlling particle diameter and particle characteristics of barium titanate particles.

Japanese unexamined patent publication H06-227816 and Japanese unexamined patent publication H08-239215 describe, in order to control particle diameter of barium titanate powder, a technique wherein titanium oxide particles are coated with barium compound, such as barium mitrate, and the obtained compound powder is fired. Similarly, Japanese unexamined patent publication 2002-265278 describes a technique wherein the surface of titanium dioxide particles are coated with barium alkoxide compound and the coated particles are fired to obtain barium titanate particles. However, with the methods described in Japanese unexamined patent publications H06-227816, H08-239215 and 2002-265278, process to form barium compound layer on the surface of titanium oxide is complicated and also the obtained barium compound layer is not always uniform. Further, there is a possibility that irregular shaped and large particles may be produced by particle bonding through the barium compound layer.

Generally, production reaction of barium titanate from barium carbonate and titanium dioxide is expressed by the following formula;

BaCO₃+TiO₂→BaTiO₃+CO₂.

The reaction is known to proceed in two-stages (J. Mater. Rev. 19, 3592 (2004)). Namely, the first stage reaction is a production reaction of barium titanate on the surface (contact area of barium carbonate and titanium dioxide) of titanium dioxide particles proceeded at 500 to 700° C., and the second stage reaction is a reaction wherein barium ion species diffuse in titanium dioxide within the resulting product of the first stage reaction, proceeded at 700° C. or more.

Accordingly, as is the same with Japanese unexamined patent publication H10-338524 and H11-199318, when performing heat treatment of mixed powder in one-stage at 900° C. or more, particle growth of raw particles, production reaction of barium titanate on the surface of titanium dioxide particles, diffusion of barium ion species, and particle growth of barium titanate particles, etc. occur in a short time. As a result, particle diameter and particle characteristics of the obtained barium titanate particles show variations.

### SUMMARY OF THE INVENTION

An object of the present invention is to provide particulate dielectric particles having uniform particle diameters and particle characteristics, particularly precursor material for manufacturing barium titanate particles, and the manufacturing method thereof.

Keen examination was performed to attain the object and the inventors have focused on that the particle growth of barium titanate particles occurs at 900° C. or more.

By producing barium titanate phase on the surface of titanium dioxide particles, mutual contact among titanium dioxide particles will be reduced, and particle growth and bonding of titanium dioxide particles will be inhibited. Further, the barium titanate phase existing on the surface of titanium dioxide particles contribute to particle bonding and particle growth at relatively high temperature, therefore, particle bonding and particle growth of titanium dioxide particles having barium titanate phase on the surface is not likely to occur until it reaches high temperature. Accordingly, the inventors have found that by obtaining titanium dioxide powder having barium titanate phase on the surface, adding alkaline earth compound and rare earth compound to said powder so as to be within a desired composition range of dielectric particles, and heat treating the powder; particle growth of titanate dioxide particles as a raw material, and dielectric particles as a product, such as barium titanate particles at an early stage of heat treatment process will be inhibited, and dielectric particles having a high crystallinity and uniform particle characteristics are obtained. The inventors have conceived of the following invention based on such findings.

The present invention solving the above-mentioned problems comprises the following subject matter.

(1) Composite oxide particles substantially consisting of 75 to 25 mol % barium titanate phase and 25 to 75 mol % titanium dioxide phase.
(2) The composite oxide particles as set forth in (1) wherein the barium titanate phase is formed on the surface of titanium dioxide particles.
(3) A manufacturing method of composite oxide particles comprising;

a mixed powder preparing step wherein titanium dioxide particles and barium compound particles, producing barium oxide by heat decomposition, are mixed in a ratio of 25 to 75 mol % of barium to 100 mol % of titanium, and

a first heat treating step wherein the mixed powder is heated at a temperature of 500° C. or more to less than 900° C. and making all barium compounds react, to thereby producing composite oxide particles substantially consisting of 75 to 25 mol % barium titanate phase and 25 to 75 mol % titanium dioxide phase.

(4) A manufacturing method of dielectric particles comprising;

a first mixed powder preparing step wherein titanium dioxide particles and barium compound particles, producing barium oxide by heat decomposition, are mixed in a ratio of 25 to 75 mol % of barium to 100 mol % of titanium,

a first heat treating step wherein the first mixed powder is heated at a temperature of 500° C. or more to less than 900° C. and making all the barium compounds react, to thereby producing composite oxide particles substantially consisting of ˜75 to 25 mol % barium titanate phase and 25 to 75 mol % titanium dioxide phase,

a second mixed powder preparing step wherein alkaline earth compound and/or rare earth compound are further mixed to the obtained composite oxide particles, and

a second heat treating step wherein the second mixed powder is heated at a temperature of 850 to 1000° C.

According to the invention, barium titanate fine particles having uniform particle characteristics and a high crystallinity can be obtained while inhibiting particle growth at barium titanate manufacturing process.

It is not theoretically constrained, however, the inventors consider that the above-mentioned effects are caused by the following reaction mechanism.

Namely, mutual contacts among titanium dioxide particles during the first heat treating step are inhibited by producing barium titanate phase on the surface of titanium dioxide particles in the first heat treating step. As a result, particle growth (necking and particle bonding) of titanium dioxide particles is inhibited and a production of impurity intermediate (Ba₂TiO₄) caused by nonuniform reaction is also reduced.

Next, in the second heat treating step, alkaline earth ion (barium ion) and rare-earth ion species are dispersed in the composite oxide to further expand dielectric phase (barium titante phase), and dielectric particles (barium titanate particles) are finally obtained. This step is performed at relatively high temperature. If barium titanate phase is not formed on the surface of titanium dioxide particles, necking or particle bonding via exposed titanium dioxide may occur, causing irregular particle growth. In this case, the obtained barium titanate particles become irregular shaped particle and uniform barium titanate particles cannot be obtained. However, according to the invention, barium ion species are dispersed without causing a particle growth of titanium dioxide particles since the surface of titanium dioxide particles is covered with barium titanate phase. As a result, barium titanate fine particles having uniform particle characteristics can be obtained.

Further, since the obtained barium titanate particles are fine particles, particle growth can be performed to make particles a desired size by undergoing the second heat treatment. Heat treatment is further performed during the particle growth process, consequently producing barium titanate particles having a high crystallinity.

### BRIEF DESCRIPTION OF DRAWINGS

FIG. 1 is X-ray diffraction patterns of composite oxide particles obtained by example 4 and comparative example 3.

FIG. 2 is scanning electron microscope photographs (SEM pictures) of barium titanate powder obtained from example 4-3 and comparative example 4.

### DESCRIPTION OF THE PREFERRED EMBODIMENTS

Present invention, including preferred embodiments of the invention, will further be described in detail below. The description below particularly exemplifies a manufacturing method of barium titanate as dielectric particles, however, said method is applicable to manufacturing methods of various kinds of dielectric particles comprising heat treatment process of a mixed powder including titanium dioxide particles and barium compound particles, such as (Ba, Sr)TiO₃, (Ba, Ca)TiO₃, (Ba, Sr) (Ti, Zr)O₃, (Ba, Ca) (Ti, Zr)O₃.

Composite oxide particles of the invention, preferably used as a precursor for manufacturing dielectric particles, consist substantially of barium titanate phase and titanium dioxide phase.

Ratio of barium titanate phase in the composite oxide particles is 75 to 25 mol %, preferably 75 to 40 mol %, more preferably 75 to 50 mol % and the same of titanium dioxide phase is 25 to 75 mol %, preferably 25 to 60 mol %, more preferably 25 to 50 mol %. The composite oxide particles substantially consists of said two phases, and unreacted barium compound phase or different phase including excessive titanium (BaTi₂O₅, BaTi₄O₉, etc.) is substantially not included. Ratio of said unreacted and different phases is 1 mol % or less.

The above barium titanate phase, considering its producing mechanism, is possibly formed on the surface of titanium dioxide particles as cover layer. 3 nm or more thickness of barium titanate phase is formed on the surface of titanium dioxide particles, and that titanium dioxide phase is possibly not exposed.

When the ratio of barium titanate phase in composite oxide particles is excessively low, ratio of barium titanate phase on the surface of titanium dioxide particles becomes insufficient, deteriorating shielding effect of barium titanate phase on the surface of titanium dioxide particles. As a result, mutual contact among titanium dioxide particles causes mutual sintering among said particles and irregular particle growth may occur.

Ratio and an average thickness of barium titanate phase can be controlled by suitably selecting a ratio of titanium dioxide particles and barium compound particles in the first heat treatment step mentioned below. Namely, ratio and an average thickness of barium titanate phase increase as ratio of barium compound increases.

Production of predetermined barium titanate phase in composite oxide particles of the present invention can be confirmed by X-ray diffraction analysis and transmission electron microscope analysis.

Next, a manufacturing method of the composite oxide particles mentioned above is explained. The composite oxide particles are obtained by heat treating (hereinafter, sometimes referred as “the first heat treatment”) the mixed particles (hereinafter, sometimes referred as “the first mixed powder”) including titanium dioxide particles and barium compound particles, which produces barium oxide by heat decomposition, at a predetermined ratio and at a temperature of 500° C. or more and less than 900° C.

Titanium dioxide particles used as raw material is not particularly limited but have BET specific surface area of preferably 20 m²/g or more, more preferably 25 m²/g or more, and the most preferably 30 m²/g or more. Titanium dioxide particles of higher BET specific surface area, namely, the smaller particle diameter, are preferable for improvement in reactivity and obtaining barium titanate fine particles. However, excessively small barium titanate particles may become difficult to handle. Therefore, in order to improve productivity, around 20 to 80 m²/g is preferable.

Titanium dioxide particles used in the invention can be manufactured by any method, and also, can be a commercially available product or a product obtained by pulverizing said commercially available product. Particularly, titanium dioxide particles obtained by gas-phase method using titanium tetrachloride as raw material are preferably used since titanium dioxide fine particles having a low rutile content can be obtained.

A general titanium dioxide manufacturing method by gas-phase method is well-known; that is, particulate titanium dioxide particles are obtained by oxidizing a raw material of titanium tetrachloride using oxidized gas, such as oxygen or water vapor, under reactive condition of around 600 to 1200° C. When reactive temperature is too high, an amount of titanium dioxide having a high rutile content tends to increase. Accordingly, the reaction is preferably performed at around 1000° C. or less.

Barium compound, producing barium oxide by heat decomposition, can be barium carbonate (BaCO₃), barium hydroxide (Ba(OH)₂), etc. Combination of two or more kinds of barium compounds can also be used, however, barium carbonate particles are preferably used for reasons of availability. Said barium carbonate particles are not particularly limited, and well-known barium carbonate particles can be used. However, in order to accelerate solid-phase reaction and obtain particulate barium titanate particles, raw material particles having relatively small diameter are preferably used. Therefore, BET specific surface area of barium compound particles used as raw material is preferably 10 m²/g or more, and more preferably 10 to 40 m²/g.

Ratio of raw material powder in the first mixed powder is determined according to a composition of composite oxide particles in object. And titanium dioxide and barium compounds are mixed in a barium ratio of 25 to 75 mol %, preferably 40 to 75 mol %, more preferably 50 to 75 mol % with respect to 100 mol % of titanium.

Preparation method of said first mixed powder is not limited, and common methods such as wet mixing method using ball mill can be used. The obtained first mixed powder is dried and heat treated (the first heat treatment step) under predetermined condition, then, the composite oxide particles can be obtained.

In the first heat treatment step, said mixed powder is heat treated, producing barium titanate phase on the surface of titanium dioxide particles. Note that binder removing process can be performed before the first heat treatment process.

Heat treatment temperature during the first heat treatment step varies according to the heat treatment atmosphere, however, is lower than that of the second heat treatment step, and is a temperature wherein barium titanate phase is formed on the surface of titanium dioxide particles by a reaction of titanium dioxide particles and barium compounds, i.e. 500° C. or more and less than 900° C. Heat treatment time is a sufficient time for all the barium compounds to react and to produce barium titanate. Heat treatment atmosphere is not particularly limited and can be under air atmosphere, gas such as nitrogen atmosphere, reduced atmosphere, or vacuum atmosphere.

When heat treatment temperature is too high, particle growth of raw materials, such as barium compound particles and titanium dioxide particles, occur and it causes limit to make the resulting barium titanate particles to be fine. Further, in this case, different phase (BaTi₂O₅, BaTi₄O₉, etc.) including excessive titanium may be produced. To the contrary, when heat treatment temperature is too low or when heat treatment time is too short, residual barium compounds may exist and predetermined barium titanate phase may not be produced.

When an ordinary firing furnace is used, the first heat treatment step is conducted at preferably 500 to 900° C., more preferably 500 to 700° C., and the most preferably 600 to 700° C. Note that the ordinary firing furnace is a furnace which fires a mixed powder at static condition, such as batch furnace. Temperature rising may be conducted from room temperature or after preheating the mixed powder. In this case, holding time of heat treatment temperature is 0.5 to 4 hours, preferably 0.5 to 3 hours.

Temperature raising process to the above-mentioned heat treatment temperature is preferably conducted at a rate of around 1.5 to 20° C./min. An atmosphere during the temperature raising process is not particularly limited and can be under air atmosphere, gas such as nitrogen atmosphere, reduced atmosphere, or vacuum atmosphere.

Further, the first heat treatment step may be performed in firing furnace which performs firing of a mixed powder with fluidizing. In this case, heat treatment is conducted at preferably 500 to 900° C., more preferably 500 to 700° C., and the most preferably 600 to 700° C. Note that a rotary kiln can be exemplified as said firing furnace, which perform fluidized firing of a mixed powder. The rotary kiln is an inclined heating pipe having a mechanism which rotates around center axis of the heating pipe. A mixed powder put from upper part of the heating pipe is heated while it moves inside the pipe to its lower part. Therefore, by controlling temperature of the heating pipe and passage time of the mixed powder, achieving temperature and rate of raising temperature can be suitably controlled. In this case, holding time at the heat treatment temperature is 0.1 to 4 hours, preferably 0.2 to 2 hours.

The first heat treatment step may be performed under a reduced pressure lower than atmospheric pressure, e.g. a pressure around 8×10⁴ Pa, at 450 to 600° C., preferably 450 to 550° C. In this case, holding time of heat treatment temperature is 0.5 to 4 hours, preferably 0.5 to 3 hours. Firing under reduced pressure enables low temperature reaction, therefore, reaction speed of raw material can be accelerated while particle growth of the same can be inhibited.

Composite oxide particles of the invention can be obtained by the above first heat treatment step. The composite oxide particles are particularly preferable as a precursor for manufacturing dielectric particles as mentioned above. When manufacturing dielectric particles using composite oxide particles of the invention, predetermined additional component is added to said composite oxide particles to make a composition of all the mixed powder to almost the same as that of the aimed dielectric particles, and then, the second heat treatment step mentioned hereinafter is performed.

The additional component added to the composite oxide particles varies according to composition of the aimed dielectric particles, but is generally alkaline earth compound and/or rare earth compound.

When manufacturing barium titanate (BaTiO₃), for example, barium compound can be added. Note that, Ba/Ti mole ratio of barium titanate stably obtained by ordinal one-step firing process is around 0.990 to 1.010, however, such unexpected effect given by the invention that barium titanate having mole ratio of 0.985 to 1.015 can be obtained by the manufacturing method of the invention.

Further, when manufacturing (Ba, Sr)TiO₃ or (Ba, Ca)TiO₃, predetermined amount of barium carbonate, strontium carbonate, calcium carbonate, etc. are added. Furthermore, when synthesizing (Ba, Sr)(Ti, Zr)O₃ or (Ba, Ca)(Ti, Zr)O₃, compound of zirconium source, such as ZrO₂, is added in addition to the aforementioned compound.

In order to give various characteristics to the finally obtained dielectrics, rare earth compound which become rare earth source may be added. Said rare earth compound is not particularly limited and can be various rare earth oxides (Re₂O₃). Said rare earth oxides are not particularly limited, but oxides of Y, Eu, Gd, Tb, Dy, Ho, Er, Tm or Yb can be exemplified.

The above additional components are added to the composite oxide particles and mixed by the same method, as for preparing the aforementioned first mixed powder, to prepare the second mixed powder, then, the second heat treatment step is performed. Heat treatment temperature during the second heat treatment step is 850 to 1000° C., preferably 850 to 950° C. According to the invention, since the second heat treatment step is performed after forming composite oxide particles having barium titanate phase by the first heat treatment process, barium titanate particles having a high tetragonality, a high crystallinity, and uniform particle characteristics can be obtained even at a low temperature, i.e. 1000° C. or less. Further, heat treatment time is a sufficient time for substantially completing the solid phase reaction between the composite oxide particles and the added components. Holding time at said heat treatment temperature is generally 0.5 to 4 hours, preferably 0.5 to 2 hours. Heat treatment atmosphere is not particularly limited and can be under air atmosphere, gas such as nitrogen atmosphere, reduced atmosphere, or vacuum atmosphere. When heat treatment temperature is too low or when heat treatment time is too short, there is a possibility that barium titanate particles having uniform characteristics cannot be obtained.

Temperature raising process to the above-mentioned heat treatment temperature is preferably conducted at a rate of around 1.5 to 20° C./min. An atmosphere during the temperature raising process is not particularly limited and can be under air atmosphere, gas such as nitrogen atmosphere, reduced atmosphere, or vacuum atmosphere.

An ordinary electrical furnace, such as batch furnace, can be used for the second heat treatment step. A rotary kiln can be used when continuous heat treatment is required for large amount of mixed powder.

By the second heat treatment process, additional components (barium ion species, for example) are dispersed via barium titanate phase of composite oxide particles formed by the first heat treatment step, and dielectric particles (barium titanate particles) having small diameter are obtained at an early stage of the second heat treatment. Particle growth of these fien dielectric particles is performed by continuous heat treatment. Therefore, according to the invention, dielectric particles having desired particle diameter can be easily obtained by suitably setting a heat treatment time of the second heat treatment step. Present invention, in particular, provides dielectric particles having uniform particle characteristics; therefore, abnormal particle growth will be inhibited even when the particle growth proceeds. After the heat treatment, temperature is lowered to obtain dielectric particles. Temperature lowering rate is not particularly limited, but may be around 3 to 100° C./min. in view of safety issue.

According to the invention, particle growth is inhibited during the production of dielectric particles, therefore, dielectric particles, typically miniaturized barium titanate fine particles, having uniform particle characteristics and a high crystallinity can be obtained at an early stage of the heat treatment.

“c/a”, an indicator for tetragonality of the obtained barium titanate particles, is figured by X-ray diffraction analysis, and is preferably 1.008 or more, more preferably 1.009 or more.

Further, particle characteristics are estimated by X-ray diffraction analysis or scanning electron microscope and evaluated by calculating particle diameter variations. Said particle diameter variations can be confirmed by an average particle diameter and standard deviation of particle diameters, for example. Furthermore, particle characteristics can be also estimated by specific surface area figured by BET method.

The resulting barium titanate powder substantially does not include unreacted additional component or different phase (BaTi₂O₅, BaTi₄O₉, etc.) including excessive titanium; and is extremely uniform.

Dielectric particles (barium titanate particles), obtained according to the invention, are pulverized if needed, and then, added to raw material for manufacturing dielectric ceramics or paste for forming electrode layer. Various known methods can be used for manufacturing dielectric ceramics without any limitation. For instance, subcomponent used for manufacturing dielectric ceramics can be suitably selected according to targeted dielectric characteristics. Further, paste and green sheet preparation, electrode layer formation, and green body sintering also can be suitably performed pursuant to known methods.

Hereinbefore, the invention was described exemplifying manufacturing method of barium titanate as dielectric particles, however, said method of the invention can be used for manufacturing various dielectric particles comprising a step of heat treating a mixed powder including titanium dioxide particles and barium compound particles. For instance, when synthesizing (Ba, Sr)TiO₃, (Ba, Ca)TiO₃, (Ba, Sr)(Ti, Zr)O₃ or (Ba, Ca) (Ti, Zr)O₃, compounds of Sr source, Ca source, and Zr source are added during the above-mentioned solid-phase reaction, or said compounds are added after synthesizing barium titanate, then, heat treated (fired).

### Examples

Below, the present invention will be explained in further detail according to examples however, the invention is not limited to these examples.

Titanium dioxide powder having BET specific surface area of 31 m²/g and barium carbonate powder of 26 m²/g were used as starting materials.

### Comparative Example 1 and Examples 1 and 2

### Preparation of the First Mixed Powder

Said barium carbonate particles and titanium dioxide particles were weighed to make BaCO₃/TiO₂ (mole ratio) to be 60/100, wet mixed for 24 hours by 500 cc volume of poly pot using zirconia (ZrO₂) media, and then, dried by a dryer to obtain the mixed powder. Slurry concentration of wet mixing was 20 wt %.

[The First Heat Treatment Step]

Temperature of the first mixed powder was elevated from room temperature to the first heat treatment temperature (T₀) shown in table 1 at a heating rate of 3.3° C./min. (200° C./h.) by an electrical furnace (batch furnace). Then, the powder was held for 2 hours at heat treatment temperature and the temperature was lowered at a rate of 3.3° C./min. (200° C./h.).

Note that heat treatment in example 1 was proceeded under a reduced pressure (8×10⁴ Pa) at the first heat treatment temperature (T₀=500° C.), in example 2, under atmospheric pressure at the first heat treatment temperature (T₀=550° C.), and in comparative example 1, under atmospheric pressure at the first heat treatment temperature (T₀=450° C.).

Powdery X-ray diffraction analysis of the product obtained by the first heat treatment process was performed, and produced amount of barium titanate and residual amount of raw material were measured. The measurement was performed under the following conditions. Results are shown in Table 1.

(Powdery X-Ray Diffraction Analysis)

D8 ADVANCE, a fully automatic and multipurpose x-ray diffraction device from BRUKER AXS, was used, with Cu—Kα, 40 Kv, 40 mA, 2θ: 20 to 120 deg, and detected by one dimensional super speed detector LynxEye, 0.5 deg divergence slit and 0.5 deg scatter slit. And, the product was scanned at 0.01 to 0.02 deg at scan speed of 0.3 to 0.8 s/div. For the analysis, Rietvelt analysis software (Topas from Bruker AXS) was used and weight concentrations of barium titanate and unreacted raw material powder were calculated.

### Examples 3 to 6 and Comparative Examples 2 and 3

Except for changing composition [BaCO₃/TiO₂ (mole ratio)] of the first mixed powder and the first heat treatment temperature (T₀) as described in Table 1, heat treatment was performed under atmospheric pressure similar to Example 2. Powdery X-ray diffraction analysis of the product obtained by the first heat treatment process was performed, and produced amount of barium titanate and residual amount of raw material powder were measured. Results are shown in Table 1.

TABLE 1

| | Composition | | The first | | | | |
|---|---|---|---|---|---|---|---|
| | ratio of | | heat | | | | |
| | the first mixed | | treatment | Composition of | | | |
| | powder | | temperature | composite oxide particles | | | |
| | BaCO₃ | TiO₂ | T0 | BaTiO₃ | BaCO₃ | TiO₂ | |
| | mol % | mol % | ° C. | mol % | mol % | mol % | Remarks |
| Comp. Ex. 1 | 30 | 100 | 450 | 8 | 17 | 75 | Incomplete |
| | | | | | | | reaction |
| Ex. 1 | 30 | 100 | 500 | 30 | <1 | 70 | Firing under |
| | | | | | | | reduced |
| | | | | | | | pressure |
| Ex. 2 | 30 | 100 | 550 | 30 | <1 | 70 | Firing under |
| | | | | | | | atmospheric |
| | | | | | | | pressure |
| Ex. 3 | 40 | 100 | 600 | 40 | <1 | 60 | Firing under |
| | | | | | | | atmospheric |
| | | | | | | | pressure |
| Ex. 4 | 60 | 100 | 700 | 60 | <1 | 40 | Firing under |
| | | | | | | | atmospheric |
| | | | | | | | pressure |
| Ex. 5 | 60 | 100 | 800 | 60 | <1 | 40 | Firing under |
| | | | | | | | atmospheric |
| | | | | | | | pressure |
| Ex. 6 | 60 | 100 | 870 | 60 | <1 | 40 | Firing under |
| | | | | | | | atmospheric |
| | | | | | | | pressure |
| Comp. Ex. 2 | 60 | 100 | 900 | 61 | <1 | 33 | Precipitation of |
| | | | | | | | different phase |
| | | | | | | | including |
| | | | | | | | excessive Ti |
| Comp. Ex. 3 | 60 | 100 | 1000 | 64 | <1 | 14 | Precipitation of |
| | | | | | | | different phase |
| | | | | | | | including |
| | | | | | | | excessive Ti |

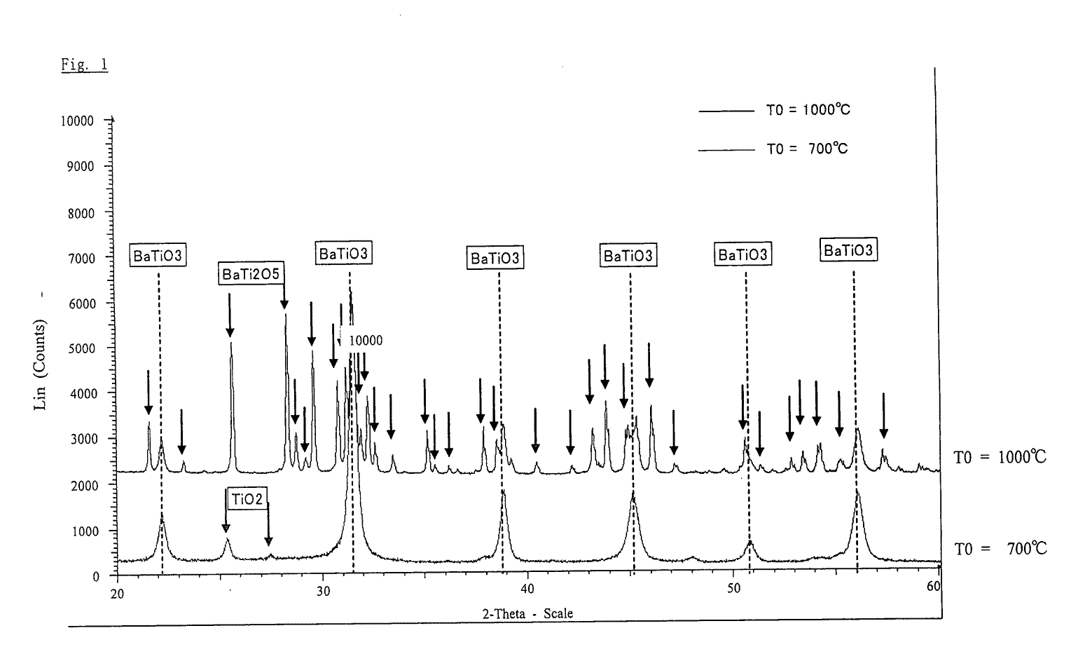

X-ray diffraction patterns of composite oxide particles obtained by Ex. 4 and Comp. Ex. 3 are shown in FIG. 1. From the above, it can be noticed that the reaction at the first heat treatment temperature of 450° C. was incomplete and that a large amount of unreacted raw material powder remained. Further, at the first heat treatment temperature of 900° C. or more, different phase including excessive Ti was produced.

### Examples 4-1 to 4-6

### Preparation of the Second Mixed Powder

The second mixed powder was prepared by adding barium carbonate particles to the composite oxide particles obtained from Ex. 4 to make Ba/Ti ratio as shown in table 2, and then, mixed similar to Ex. 1.

[The Second Heat Treatment Step]

Temperature of the second mixed powder was elevated from room temperature to the second heat treatment temperature (T₁) shown in table 2 at a heating rate of 3.3° C./min. (200° C./h.) by an electrical furnace (batch furnace). Then, the powder was held for 2 hours under atmospheric pressure at the heat treatment temperature and the temperature was lowered at a rate of 3.3° C./min. (200° C./h.).

For the obtained barium titanate particles, specific surface area was measured by BET method, “c/a”, an indicator for tetragonality was figured by X-ray diffraction analysis, existence or nonexistence of different phase was confirmed, and further, crystal particle diameters were measured and its variations were evaluated. Results are shown in Table 2.

(Specific Surface Area)

By the use of NOVA2200 (a rapid specific surface area measurement device), specific surface area was measured under the following conditions; a total amount of 1 g, nitrogen gas, single point method, deaerating condition, and 15 minutes of holding time at 300° C.

(Podery X-Ray Diffraction Analysis)

The a and c axes of the obtained barium titanate powder were measured by X-ray diffraction analysis; and “c/a”, an indicator for tetragonality, and crystal particle diameter were figured. Further, considering a quantitative amount of barium carbonate calculated from the analysis software, barium carbonate of 1 wt % or more is considered as a different phase.

D8 ADVANCE, a fully automatic and multipurpose x-ray diffraction device from BRUKER AXS, was used with Cu—Kα, 40 Kv, 40 mA, 2θ: 20 to 120 deg, and detected one dimensional super speed detector LynxEye, 0.5 deg divergence slit and 0.5 deg scatter slit were used. For the analysis, Rietvelt analysis software (Topas from Bruker AXS) was used.

Variations of particle diameters were evaluated by electron microscope (SEM) observation on the powder. “A” is for CV value of 25% or less, “B” for more than 25% and 30% or less, and “C” for more than 31%.

Note that CV value was obtained from the following expression, by measuring diameters of 200 or more particles based on SEM pictures and calculating their average diameter and standard deviation;

CV(%)=(standard deviation/average diameter)×100.

Barium titanate powder showing less variability in particle diameter, a high ratio of tetragonality, and no different phase, is evaluated to be “good”.

### Comparative Examples 4 to 7

### Preparation of Mixed Powder

Barium carbonate particles and titanium dioxide particles were weighed to make BaCO₃/TiO₂ (mole ratio) as described in table 2, wet mixed for 72 hours by 50 litters volume of ball mill, using zirconia (ZrO₂) media, and then, dried to obtain mixed powder by spray drying. Said wet mixing was performed with 40 wt % of slurry concentration and an addition of 0.5 wt % of polycarboxylate type dispersion.

[Heat Treatment Process]

Temperature of the mixed powder was elevated from room temperature to the second heat treatment temperature (T₁) shown in table 2 at a heating rate of 3.3° C./min. (200° C./h.) by an electrical furnace (batch furnace). Then, the powder was held for 2 hours at heat treatment temperature and the temperature was lowered at a rate of 3.3° C./min. (200° C./h.). Results are shown in Table 2.

TABLE 2

| | Composite oxide particles | | | Barium titanate powder | | | | | | |
|---|---|---|---|---|---|---|---|---|---|---|
| | Composition of | | The first heat | | The second heat | specific | | | | |
| | composite | | treatment | Finally | treatment | surface | | | | |
| | oxide particles | | temperature | obtained | temperature | area | | Variability | | |
| | BaTiO3 | TiO2 | T0 | Ba/Ti | T1 | (BET) | c/a | of particle | Different | |
| | mol % | mol % | ° C. | — | ° C. | m2/g | — | diameters | phase | Result |
| Ex. 4-1 | 60 | 40 | 700 | 0.995 | 850 | 9.5 | 1.008 | A | NONE | Good |
| Ex. 4-2 | 60 | 40 | 700 | 0.995 | 900 | 6.8 | 1.009 | A | NONE | Good |
| Ex. 4-3 | 60 | 40 | 700 | 0.995 | 950 | 4.8 | 1.010 | A | NONE | Good |
| Ex. 4-4 | 60 | 40 | 700 | 0.995 | 1000 | 4.2 | 1.010 | A | NONE | Good |
| Ex. 4-5 | 60 | 40 | 700 | 0.985 | 1000 | 5.9 | 1.009 | A | NONE | Good |
| Ex. 4-6 | 60 | 40 | 700 | 1.015 | 1000 | 8.5 | 1.008 | A | NONE | Good |
| Comp. Ex. 4 | | | | 0.995 | 1000 | 3.5 | 1.007 | C | NONE | Not Good |
| Comp. Ex. 5 | | | | 0.997 | 1000 | 4.5 | 1.007 | C | NONE | Not Good |
| Comp. Ex. 6 | | | | 1.002 | 950 | 11.6 | 1.005 | B | BaCO3 | Not Good |
| Comp. Ex. 7 | | | | 1.010 | 1000 | 7.3 | 1.005 | C | BaCO3 | Not Good |

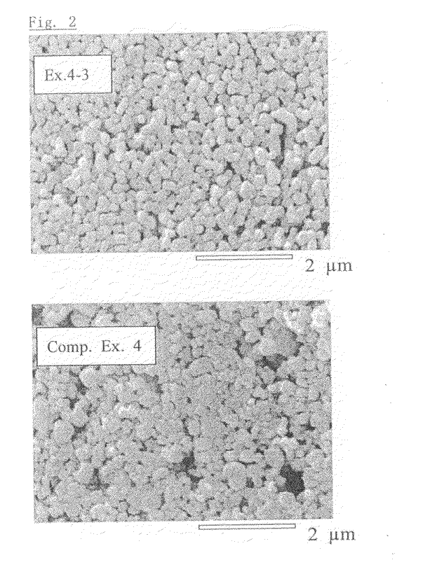

Scanning electron microscope photographs (SEM pictures) of barium titanate powder obtained from example and comparative example 4 are shown in FIG. 2. From the above, it was proved that barium titanate powder showing less variability in particle diameter, a high ratio of tetragonality, and no different phase, can be obtained by using composite oxide particles of the invention as a precursor for manufacturing barium titanate powder.

What is claimed is:

1. Composite oxide particles substantially consisting of 75 to 25 mol % barium titanate phase and 25 to 75 mol % titanium dioxide phase.

2. The composite oxide particles as set forth in claim 1, wherein the barium titanate phase is formed on the surface of titanium dioxide particles.

3. A Manufacturing method of composite oxide particles comprising;
a mixed powder preparing step wherein titanium dioxide particles and barium compound particles, producing barium oxide by heat decomposition, are mixed in a ratio of 25 to 75 mol % of barium to 100 mol % of titanium, and
a first heat treating step wherein the mixed powder is heated at a temperature of 500° C. or more to less than 900° C. and making all barium compounds react, to thereby producing composite oxide particles substantially consisting of 75 to 25 mol % barium titanate phase and 25 to 75 mol % titanium dioxide phase.

4. A manufacturing method of dielectric particles comprising;
a first mixed powder preparing step wherein titanium dioxide particles and barium compound particles, producing barium oxide by heat decomposition, are mixed in a ratio of 25 to 75 mol % of barium to 100 mol % of titanium, a first heat treating step wherein the first mixed powder is heated at a temperature of 500° C. or more to less than 900° C. and making all the barium compounds react, to thereby producing composite oxide particles substantially consisting of 75 to 25 mol % barium titanate phase and 25 to 75 mol % titanium dioxide phase,
a second mixed powder preparing step wherein alkaline earth compound and/or rare earth compound are further mixed to the obtained composite oxide particles, and
a second heat treating step wherein the second mixed powder is heated at a temperature of 850 to 1000° C.
